(19) United States
(12) Patent Application Publication
(10) Pub. No.: US 2025/0028019 A1
(43) Pub. Date: Jan. 23, 2025

(54) SYSTEM AND METHOD FOR AUTOMATED HARDWARE VERIFICATION AND MACHINE LEARNING TRAINING

(71) Applicant: Xtract One Technologies Inc., Toronto (CA)

(72) Inventors: Jonah ATKINSON, Vancouver (CA); Chris GRANSTROM, Fredericton (CA); Gudni Karl ROSENKJAER, Gibsons (CA); Jacky KAM, Delta (CA); Gabriel Gilles ROBICHAUD, Lincoln (CA); Elliot Mark HOLTHAM, Vancouver (CA); Nathan COUTURE, Fredericton (CA)

(21) Appl. No.: 18/778,206

(22) Filed: Jul. 19, 2024

Related U.S. Application Data
(60) Provisional application No. 63/514,527, filed on Jul. 19, 2023.

(51) Int. Cl. G01S 7/02; G01S 7/41; G01S 13/88

(52) U.S. Cl. CPC G01S 7/027; G01S 7/415; G01S 13/887

(57) ABSTRACT

A system and method of automated hardware verification and machine learning training using an automated object mover. The automated object mover consists of a ceiling or floor mounted rail. Two vertical poles are mounted on rails and can travel horizontally along the rails. Mechanical mechanisms are included such that the height and trajectory of the object as it passes through the gateway can be modified. Vertical poles are placed between the vertical columns and can travel through the gateway columns. Comparison of collected data from an automated data mover approach compared to a person walking through the gateway system approach produces data similar to an idealized object response for the object moving through the gateway at a constant speed and in zero environmental noise. Different types of collected data can be blended together to create a comprehensive machine learning dataset for training of robust alerting models for various objects.

### CROSS REFERENCE TO RELATED APPLICATIONS

This application claims priority to and the benefits of U.S. Provisional Application Ser. No. 63/514,527, entitled “SYSTEM AND METHOD FOR AUTOMATED HARDWARE VERIFICATION AND MACHINE LEARNING TRAINING” filed on Jul. 19, 2023, the disclosure of which is incorporated herein by reference in its entirety.

### BACKGROUND

The embodiments described herein relate to hardware verification, in particular, technologies related to threat detection gateway systems.

A challenge when developing machine learning models for gateway systems is having sufficient data upon which to train the models as well as repeatable data to validate performance and compare performance across different hardware versions. Currently it is very difficult to compare the performance between different versions of the threat detection gateway systems (e.g., versions 1.0 and 2.0) because there is no easy way to collect a consistent dataset between the systems because there is too much variability in the human walkthrough data collection process. Even if the systems are arranged in series and a single person walks through the gateways in one pass, there is still a large variability in the data between systems. The data is very sensitive to minor changes in parameters such as orientation and velocity.

Training models, such as deep learning techniques, can require a tremendous number of examples to achieve the best possible accuracy. For example, vision and language application are often trained on millions or billions of examples. Collecting this much data can be very challenging to achieve in a reasonable timeframe using manual techniques such as having a person walk through the gateway repeatedly with different walkthrough speeds, trajectories and objects etc. Typically, gateway system models are trained on thousands or tens of thousands of examples.

Verifying that the entire hardware and software gateway system is working correctly can also be challenging because it's not easy to create a repeatable test of the entire system. Individual components such as coils can be tested, but ultimately the full system including machine learning alerting requires the entire system to be operating simultaneously. The problem is when testing the system using human operators there is so much variability of walkthroughs that it's difficult to separate differences in hardware and software from variability in walkthrough dynamics such as speed and orientation of the object.

It may be desirable to provide a system and method for automated hardware verification and machine learning training by using automated tools to verify and train object detection gateways.

### SUMMARY

A system and method of automated hardware verification and machine learning training by using an automated object mover to verify and train object detection gateways. The automated object mover consists of a ceiling or floor mounted rail. Two vertical poles are mounted on rails and can travel horizontally along the rails. Mechanical mechanisms are included such that the height and trajectory of the object as it passes through the gateway can be modified.

The vertical poles are placed between the vertical columns of the multi-sensor gateway wherein the vertical poles can travel vertically and horizontally through the multi-sensor gateway columns. Comparison of collection of data from an automated data mover compared to a person walking through the gateway system produces data similar to an idealized object response for the object moving through the gateway at a constant speed and in zero environmental noise. Different types of collected data can be blended together to create a comprehensive machine learning dataset for training of robust alerting models for various objects.

### BRIEF DESCRIPTION OF THE DRAWINGS

FIGS. 1A-1C are diagrams illustrating an exemplary threat detection system.

FIG. 2 is a block diagram illustrating an exemplary threat detection system.

FIG. 3 is a further block diagram illustrating a further embodiment of a threat detection system.

FIG. 4 is a diagram of an exemplary automated object mover.

FIG. 5 is a diagram of an exemplary automated object mover in the lab.

FIG. 6 is a diagram comparing data collected from automated data mover on the left, compared to person walkthrough on the right.

FIG. 7 is a diagram illustrating different types of data can be blended together to create a comprehensive machine learning dataset for training of robust alerting models for various objects.

### DETAILED DESCRIPTION

Embodiments of this disclosure include a threat detection gateway system that includes onboard processor and computing. Further, different peripherals are added to present the alert information to the security guard, as well as control the throughput rate and operations. This system benefits the patron experience and provides added value to the customer in terms of managing throughput and enhancing security.

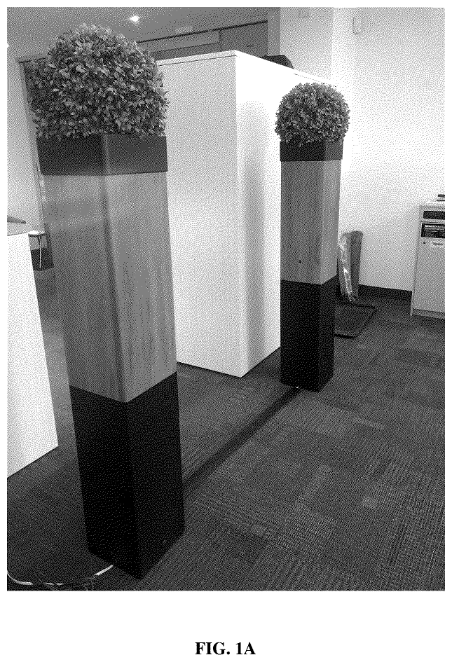

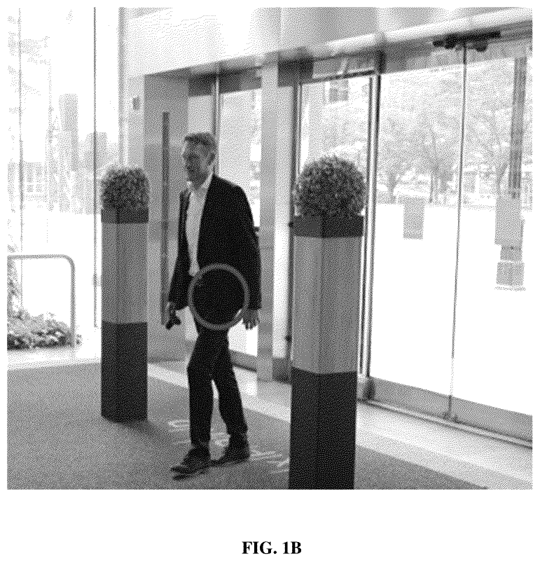

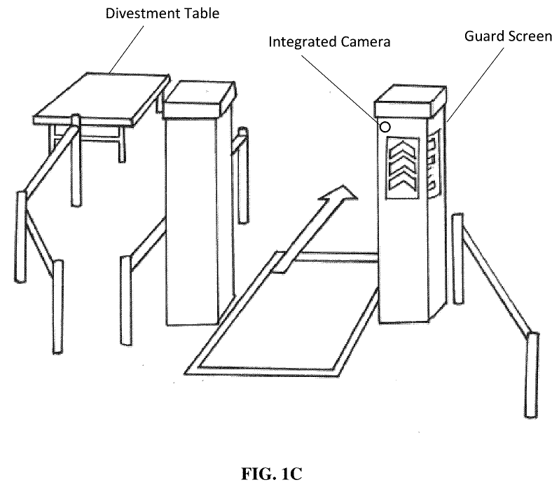

FIGS. 1A-1C are diagrams illustrating an exemplary threat detection gateway system deployed in planter boxes. According to these figures, planter boxes are deployed at the entrance to an office and/or at a pair of pillars to control entry. A pair of planter box columns are placed sufficiently far apart (i.e., 2 meters).

Decorative plants, either fake or real, are placed on the planter boxes. The planter boxes or planter box columns are connected via concealed wires where a cover is placed on top. The concealed wires provide power and Ethernet connection between both columns. In further embodiments, the concealed wires can be replaced with a wireless connection or another type of data connection. The planter box columns contain sensors to implement a threat detection system. At least one of the columns will also have a power cord and/or connection to the internet.

FIG. 1B is a diagram of an exemplary threat detection system deployed in planter boxes in a front entrance of a building. As seen in FIG. 1B, two planter box columns are placed by the front door in a building. A person can be seen entering the building, walking through these planter box columns.

A threat detection system using a multi-sensor gateway (MSG), such as the Xtract One PATSCAN MSG offers detection of concealed weapons on people and in bags using artificial intelligence (AI) and/or machine learning (ML) coupled with magnetic moment techniques. The multi-sensor gateway (MSG) allows for the discovery of a “weapon signature” (i.e., object shape such as handguns, rifles, knives or bombs). Its configuration can detect and identify where on the individual's body or bag the metal threat object resides.

As seen in FIG. 1B, the MSG threat detection system can detect a concealed object (i.e., round circle in image) and may infer that this can be a weapon threat. This information is sent to a central processor and is provided to an operator, security officers or to police enforcement. Further, the MSG threat detection system may be connected to an alert system where lights and sounds can be triggered once a threat is detected.

FIG. 1C is a diagram illustrating a standalone SmartGateway system. According to FIG. 1C the standalone SmartGateway system consists of two pillars of a threat detection system. One of these pillars will have an integrated camera, a display screen and a guard screen (not shown). There may also be arrows to indicate the direction of traffic flow. Close by would be a divestment table where security personnel may search objects of the patron (e.g., backpack, handbag, laptop bags, etc.).

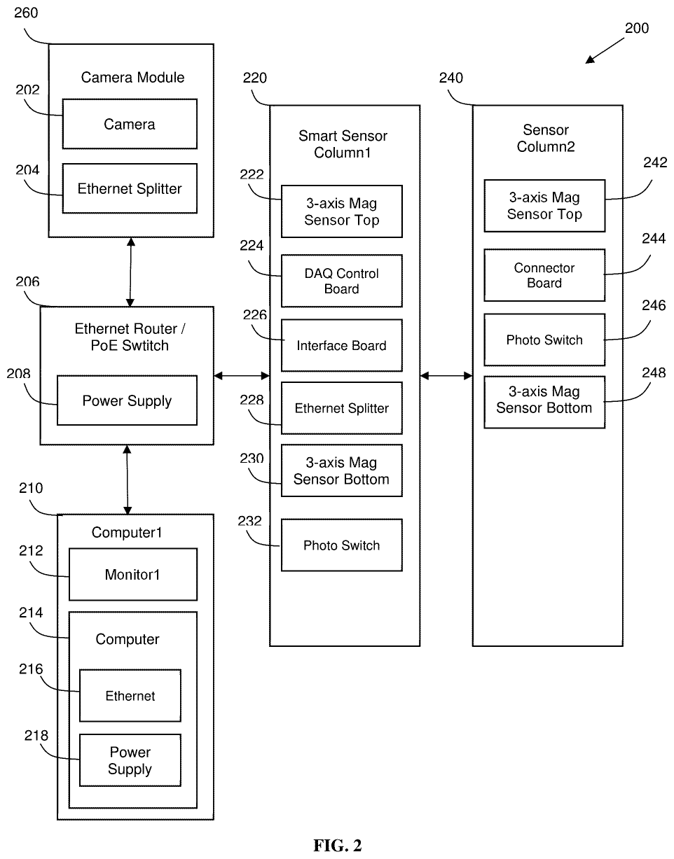

FIG. 2 is a block diagram illustrating an exemplary threat detection system. According to FIG. 2, the threat detection system 200 consists of a first sensor column 220 (i.e., smart column) which includes a photoelectric sensor 232 (e.g., photo switch), a power supply 232, a computer control board 224 (e.g., a LabJack DAQ board), an interface board 226 and a plurality of 3-axis magnetic sensors 222, 230. Connection interfaces for ethernet router 206, ethernet splitters 204, 228, and ethernet PoE (power of Ethernet) are also provided. Photoelectric sensor 232 may also include a photo emitter.

While Ethernet, and in particular powered Ethernet provides many advantages in reliably connecting the columns to the data analysis computer, several other power and connectivity options are available that would have a different set of advantages; for example connections to route the data could be WiFi® connections, BlueTooth® connections, short range wireless, WAN or cellular connections. In addition, power can be supplied to the columns via several means, including direct AC power connections, PoE, 12V DC connections, or battery connections. In future embodiments, first sensor column 220 may incorporate a computer processor.

The threat detection system 200 also consists of a second sensor column 240 comprising a second photoelectric sensor 246 (e.g., photo switch), a connector board 244 and a plurality of 3-axis magnetic sensors 242 and 248. A plurality of wires is provided to connect the interface board 226 of the first column 220 with the connector board 244 of the second column 240. Photoelectric sensors or photo switches 246, 232 are optical sensors that detect motion when people pass through. In further embodiments, sensor columns 220, 240 may include dedicated power supplies.

Attached to the first smart sensor column 220 includes an ethernet router and PoE (Power over Ethernet) switch 206, which can be connected to a 48V power supply 208, a computer system 210 and a camera module 260. The computer system 210 consists of monitor 212 and computer 214 which may be a laptop or small size computer unit. Computer 214 further comprises a computer processor (not shown), power supply 218 and ethernet connection 216. Camera module 260 consists of one or more cameras 202 and ethernet splitter 204.

In further embodiments, the computer 210, 214 may be replaced by a processor housed within the sensor columns 220, 240. In further embodiments, the ethernet connection of threat detection system 200 may be replaced with a Bluetooth®, cellular or WiFI® wireless connection, thus removing the need for running ethernet cables.

According to the disclosure, a hybrid multi-sensor gateway (MSG) system combines the two MSG system transmitters and receivers into a single gateway. The hybrid system consists of the backbone of the system with an active transmitter loop which induces eddy currents to flow within conductive targets. Acquisition parameters such as transmitter pulse base frequency, waveform shape, ramp-time and peak current etc. can be modified and tuned to the specific applications and expected targets.

MSG sensors are added to the system. MSG sensors may include inductive coil sensors and are wound around a very high susceptibility material which greatly increases the sensitivity of the sensors. Furthermore, MSG sensors are tuned for a much lower frequency, typically recording responses in the 0.3-30 Hz frequency range which is needed to measure the low frequency passive response as magnetized objects pass through the gateway. Different embodiments of the hybrid system are possible including or not including the addition of the static magnetic array.

Further embodiments of the system are possible to combine transmitters and two types of receivers for getting usable data off the MSG sensors while still using the active 2.0 transmitter. The first option is to leverage hardware filters and non-overlapping frequency ranges of the components. By using a higher frequency spectrum of the active transmitters (a few ms for a transmitter pulse) and the low frequency 0.3 Hz-10 Hz range of the 1.0 sensors, one can create frequency bands that don't overlap significantly so any active source pulse may be filtered out. Alternative embodiments are possible, where longer off-times are created for the MSG transmitter pulses-in the long-off time regions between pulses, clean passive MSG data could be collected with those sensors.

Alternative embodiments are also possible, where the MSG transmitter is only fired during specific parts of the walk-through likely triggered off optical sensors or motion information. Various potential options include collecting active data at the midpoint of the walkthrough or first/second half of the walk through, while collecting passive data through the other portion of the walkthrough.

New use cases for the gateway systems are abundant, but some specific examples could include the detection of electronics and other recording devices for shows and entertainment events so that no audio or video recordings of the events would be possible. Additional electronics use cases include security and defense situations, where banned electronic and recording devices could not be brought into classified or sensitive areas within a building.

Additionally, sensitive or digital recording devices could also not be removed from classified areas. Further electronic specific use cases include the ability to detect and discriminate between different items such as electronics for theft from retail and warehouse applications, without the need to manually place RF type tags on each piece of merchandise.

Additional gateway flexibility could be added to deploy multiple detection models simultaneously, or to incorporate external information from other sensors or data sources and use this to either change the parameters of the machine learning models (such as for example sensitivity or other parameters) or to determine which threat models are executed at run-time as the patron walks through the gateway.

An additional embodiment would be to use video or computer vision technology, including for example uniform clothing detection or facial recognition to allow security guards or other pre-screened individuals to pass through the gate. This could include the integration of vision technology to identify and allow high value clients such as VIPs and celebrities to pass unhindered through the gateway.

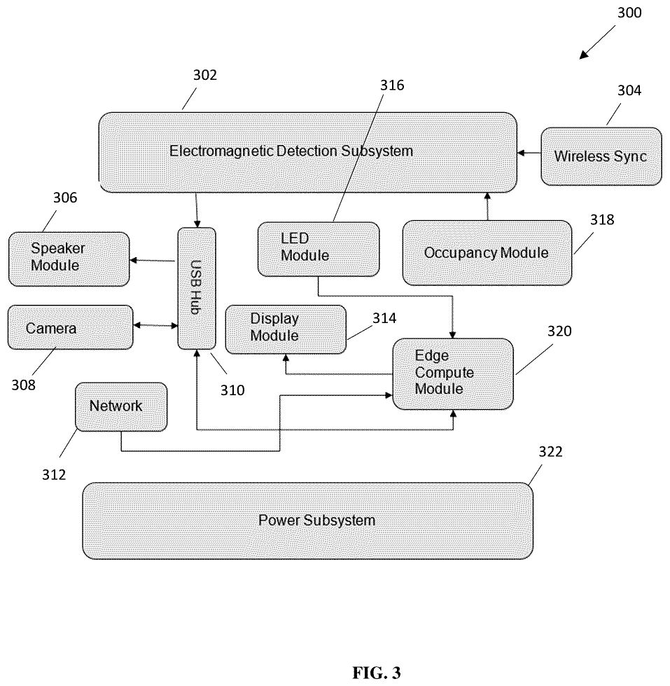

FIG. 3 is a further block diagram illustrating a further embodiment of a threat detection system. According to FIG. 3, the further threat detection system 300 comprises some or all of an Electromagnetic Detection Subsystem (EDS) 302, a wireless synch module 304, a speaker module 306, a camera or camera module 308, a USB hub 310, a network or network switch 312, a display module 314, a LED module 316, an occupancy module 318, an EDGE compute (or computer) module 320 and a power subsystem 322.

According to FIG. 3, the central components of the threat detection system 300 include the USB hub 310 and the Edge compute module 320. The EDS 302, speaker module 306, camera module 308 and Edge compute module 320 all connect to the USB hub 310. Furthermore, the LED module 316, display module 314 and network switch 312 connect to the Edge compute module 320.

According to FIG. 3, the display module 314 can be a removable display module such as a removable tablet. According to FIG. 3, the wireless sync module 304 is configured to enable wireless synchronization of the transmission pulse between two pillars of one lane, or multiple lanes.

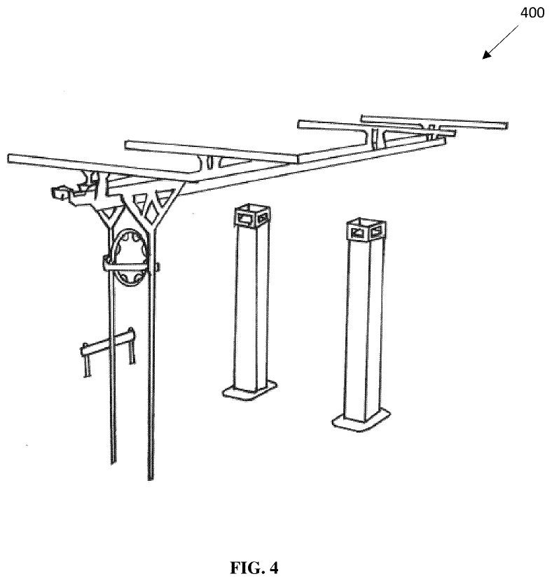

FIG. 4 is a diagram of an exemplary automated object mover 400. According to FIG. 4, an automated object mover 400 is shown being deployed for different walkthrough directions through the gateway system.

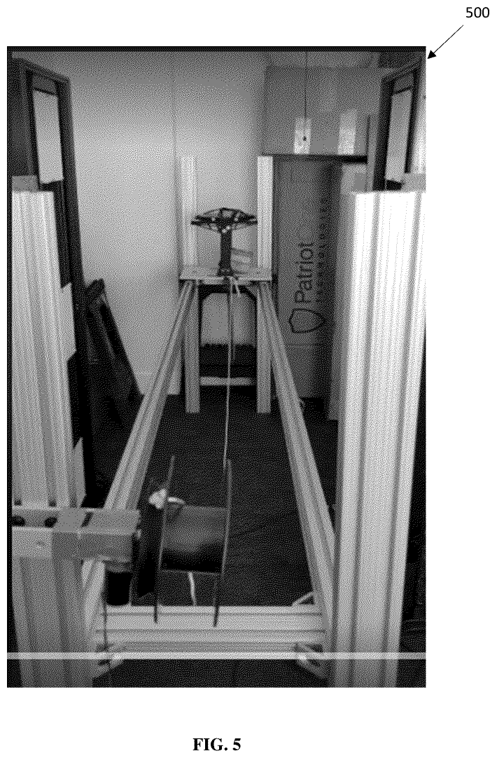

FIG. 5 is a diagram of an exemplary automated object mover 500 in a lab or testing environment. According to FIGS. 4 and 5, the automated object mover 400 or 500, or a robotic object mover approach, allows for repeatable and automatable data capture from the multi-sensor gateway.

According to FIGS. 4 and 5 the exemplary automated object mover 400 or 500 comprises a ceiling mounted rail. Two vertical poles are mounted on rails and can travel horizontally along the rails. Mechanical mechanisms are included such that the height and trajectory of the object as it passes through the gateway can be modified. The vertical poles are places between the vertical columns of the multi-sensor gateway (i.e., pillar 1 and pillar 2) wherein the vertical poles can travel vertically (i.e., controlled by mechanical vertical control) and horizontally (i.e., controlled by the horizontal rails) through the multi-sensor gateway columns. In further embodiments, instead of mounting on the ceiling, a floor mounted rail system can also be deployed.

This approach can be used for a number of applications, including:
A quality control (QC) tool to verify that the gateway system is working or to diagnose issues using a repeatable data collection procedure.
A way to automatically streamline data collection such that machine learning models can be trained quicker and more robustly.

The data collected from the robotic automated data collection system can be combined or blended with other data sources for training including fully synthetic data, automated robotic data off the real gateway system, and human collected data which would have the most variability.

The robotic automated data collection system can be designed to be flexible and programmed to collect data sweeping over a wide variety of data collection parameters such as walkthrough speed, object orientation, object type. This will allow for a very rich dataset to be collected. The walkthroughs could be programmed with stochastic elements using something similar to a Monte Carlo approach to sample object collection parameters from some distributions based on real patron behavior. For example, the walkthrough speed could be varied across different robotic passes as well as varied during individual object passes through the gateway thus ensuring maximum variability in data collection parameters.

It is difficult to ensure that, during testing, human walkers are varying the parameters sufficiently to not have gaps in potential parameter space using solely human data collection methods. Using an automated robotic approach, so long as the object collection parameter distribution are well characterized, using mathematical sampling approaches one can ensure that sufficient data examples have been collected to obtain a sufficient variety of object collection parameters

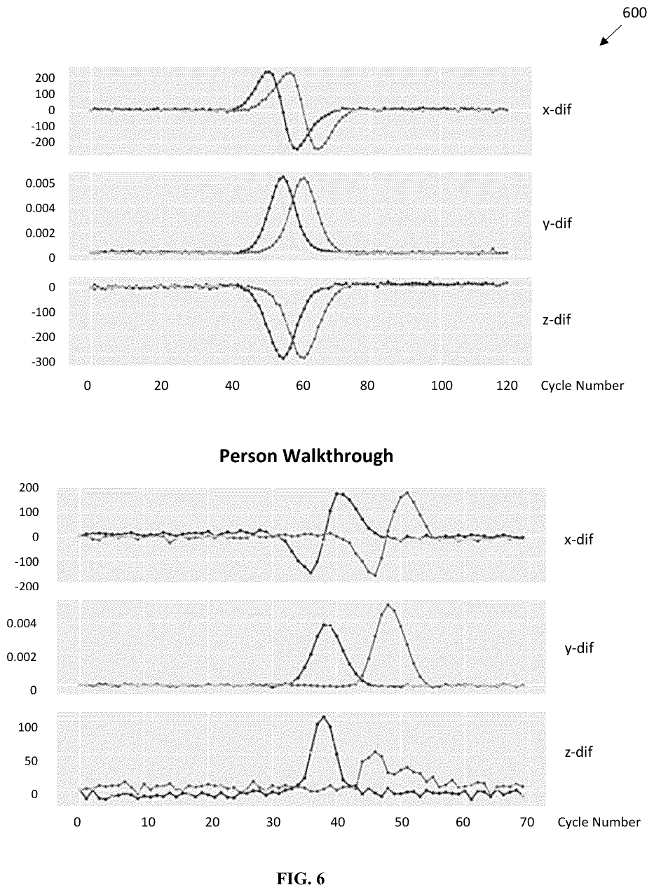

FIG. 6 is a diagram comparing data collected from an automated data mover on the left, compared to a human walkthrough on the right. According to FIG. 6, the data of diagram 600 collected using the automated object mover on the left is more similar in shape to that of an idealized response with a constant walkthrough height, velocity, orientation and zero background noise, compared to the person walkthrough on the right.

Blending synthetic with various real sources is a very common machine learning technique at the moment. Blending synthetic data with robotic data with human collected data could create very rich datasets efficiently and affordably.

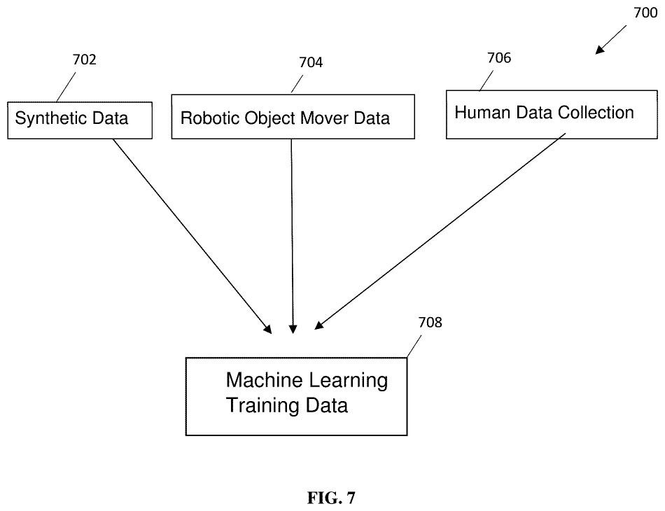

FIG. 7 is a diagram illustrating different types of data that can be blended together to create a comprehensive machine learning dataset for training of robust alerting models for various objects. According to FIG. 7, model 700 comprises of synthetic data 702, robotic object mover data 704 and human data collection data 706, all being collected and consolidated into machine learning training data 708. In a further embodiment, different versions of the data blending and staging or prioritization of data collection are also possible.

According to further aspects of the disclosure, automated testing systems are used in different industries. However, existing testing systems are mostly around testing performance of the metal detectors particularly from a standards perspective. Furthermore, the robotic approach is not for testing the performance, but for collecting sufficient data to train machine learning models. Furthermore, embodiments of the disclosure are not to test the performance of the system, but to test if the system is working correctly in the QC process.

According to further embodiments of the disclosure, further devices (i.e., FunGen) may be created to assisted with automated hardware verification. The further testing platform may include an end to end device that can test the output on the coils of the system in a simple way. The testing platform includes mounting one or more small earth magnets on a basic motor. The motor spins at an appropriate frequency for the sensor response. The system can be positioned at various points within the gateway but one option is in the mid-point of the gateway. As the magnet spins, it creates a time-varying field which can be detected by the coils. Because the magnet is always the same and the motor speed is consistent, one can use the known dB/dt field to check that each of the coordinates' (i.e., x, y and z) component sensors are working correctly and the data acquisition hardware is working correctly and that the sensors have been installed in the correct orientation (i.e., not flipped).

According to the further embodiments of the disclosure, the raw data outputs from the system can be checked for accuracy and consistency by a number of methods which include comparing against known reference outputs from correctly functioning systems, or machine learning and other statistical approaches where the output from multiple systems are analyzed simultaneously looking for outliers and other data and system anomalies.

In further embodiments, further sensors or accessories can be added to simulate more realistic environmental configurations for an automated walkthrough system. For example, a leaf blower pointed at the tower, or a pillar attachment which moves or vibrates in a consistent or characterizable way, can be used to simulate an outdoor installation where a pillar is subject to vibrations.

According to the disclosure, an automated hardware verification apparatus for calibrating a multi-sensor gateway apparatus, the multi-sensor gateway apparatus comprising a plurality of sensor and at least two vertical pillars. The automated hardware verification comprises a computer processor, an automated object mover mounted on rails, two vertical poles mounted on the rails configured to travel horizontally along the rails and a mechanical mechanism to calibrate and simulate an object passing through the pillars of the gateway.

According to the disclosure, the vertical poles of the apparatus are placed between the pillars and are configured to travel through the gateway pillars. Furthermore, the computer processor and the automated object mover is configured to collect data as the vertical poles moves along the rails across the vertical pillars.

According to the disclosure, the rails of the automated object mover are ceiling mounted or floor mounted rails. The mechanical mechanism is a pulley wheel placed between the two vertical poles. The apparatus is configured to support machine learning training.

According to the disclosure, different types of collected data are blended together to create a comprehensive machine learning dataset for training of robust alerting models for different objects. The apparatus produces data similar to an idealized object response for the object moving through the gateway at a constant speed and with no environmental noise.

According to the disclosure, the data collected is compared with the data collected from when a person walks through the gateway apparatus. The data collected is selected from a list consisting of synthetic data, robotic object mover data and human data. The data is compiled to create machine learning training data.

According to the disclosure, a computer-implemented method for gathering data on an automated hardware verification system for calibrating a multi-sensor gateway system, the multi-sensor gateway apparatus comprising a plurality of sensor and at least two vertical pillars, the automated hardware verification system further comprises a processor, an automated object mover mounted on rails and having two vertical poles and a vertically adjusted mechanical mechanism.

The method comprising the steps of adjusting the mechanical mechanism to a vertical height to simulate a person walking through the vertical pillars of the multi-sensor gateway system, moving the automated object mover, mechanical mechanism and vertical poles across and through the vertical pillars of the multi-sensor gateway system and collecting data as the vertical poles moves along the rails across the vertical pillars. The data collected is compared to a person walking through the gateway apparatus.

According to the disclosure, the rails for the automated object mover of the method are ceiling mounted or floor mounted rails. The mechanical mechanism of the method is a pulley wheel placed between the two vertical poles. The apparatus of the method is configured to support machine learning training.

According to the disclosure, different types of collected data of the method are blended together to create a comprehensive machine learning dataset for training of robust alerting models for different objects. The apparatus of the method produces data similar to an idealized object response for the object moving through the gateway at a constant speed and with no environmental noise.

According to the disclosure, the data collected of the method is selected from a list consisting of synthetic data, robotic object mover data and human data. Furthermore, the data of the method is compiled to create machine learning training data.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. An automated hardware verification apparatus for calibrating a multi-sensor gateway apparatus, the multi-sensor gateway apparatus comprising a plurality of sensor and at least two vertical pillars, the automated hardware verification comprising:
a computer processor;
an automated object mover mounted on rails;
two vertical poles mounted on the rails configured to travel horizontally along the rails; and
a mechanical mechanism to calibrate and simulate an object passing through the pillars of the gateway;
wherein the vertical poles are placed between the pillars and are configured to travel through the gateway pillars;
wherein the computer processor and the automated object mover is configured to collect data as the vertical poles moves along the rails across the vertical pillars.

2. The apparatus of claim 1 wherein the rails of the automated object mover are ceiling mounted or floor mounted rails.

3. The apparatus of claim 1 wherein the mechanical mechanism is a pulley wheel placed between the two vertical poles.

4. The apparatus of claim 1 wherein the apparatus is configured to support machine learning training.

5. The apparatus of claim 1 wherein different types of collected data are blended together to create a comprehensive machine learning dataset for training of robust alerting models for different objects.

6. The apparatus of claim 1 wherein the apparatus produces data similar to an idealized object response for the object moving through the gateway at a constant speed and with no environmental noise.

7. The apparatus of claim 1 wherein the data collected is compared with the data collected from when a person walks through the gateway apparatus.

8. The apparatus of claim 1 wherein the data collected is selected from a list consisting of synthetic data, robotic object mover data and human data.

9. The apparatus of claim 8 wherein the data is compiled to create machine learning training data.

10. A computer-implemented method for gathering data on an automated hardware verification system for calibrating a multi-sensor gateway system, the multi-sensor gateway apparatus comprising a plurality of sensor and at least two vertical pillars, the automated hardware verification system further comprises a processor, an automated object mover mounted on rails and having two vertical poles and a vertically adjusted mechanical mechanism, the method comprising the steps of:
adjusting the mechanical mechanism to a vertical height to simulate a person walking through the vertical pillars of the multi-sensor gateway system;
moving the automated object mover, mechanical mechanism and vertical poles across and through the vertical pillars of the multi-sensor gateway system; and
collecting data as the vertical poles moves along the rails across the vertical pillars.

11. The method of claim 10 wherein the data collected is compared to a person walking through the gateway apparatus.

12. The method of claim 10 wherein the rails for the automated object mover is ceiling mounted or floor mounted rails.

13. The method of claim 10 wherein the mechanical mechanism is a pulley wheel placed between the two vertical poles.

14. The method of claim 10 wherein the apparatus is configured to support machine learning training.

15. The method of claim 10 wherein different types of collected data are blended together to create a comprehensive machine learning dataset for training of robust alerting models for different objects.

16. The method of claim 10 wherein the apparatus produces data similar to an idealized object response for the object moving through the gateway at a constant speed and with no environmental noise.

17. The method of claim 10 wherein the data collected is selected from a list consisting of synthetic data, robotic object mover data and human data.

18. The method of claim 10 wherein the data is compiled to create machine learning training data.
